(19) United States
(12) Patent Application Publication
(10) Pub. No.: US 2014/0110602 A1
(43) Pub. Date: Apr. 24, 2014

(54) SCINTILLATOR PANEL AND METHOD OF MANUFACTURING THE SAME

(71) Applicant: ABYZR CO., LTD, Gyeonggi-do (KR)

(72) Inventors: Yun Sung HUH, Gyeonggi-do (KR); Tae Kwon HONG, Gyeonggi-do (KR); Gi Youl HAN, Chungcheongnam-do (KR)

(73) Assignee: ABYZR CO., LTD, Gyeonggi-do (KR)

(21) Appl. No.: 14/058,070

(22) Filed: Oct. 18, 2013

(30) Foreign Application Priority Data
Oct. 19, 2012 (KR) 10-2012-0116547

(51) Int. Cl. G01T 1/20

(52) U.S. Cl. CPC G01T 1/2002
USPC 250/488.1; 427/157; 204/192.29

(57) ABSTRACT

A scintillator panel includes a substrate, a reflection layer, a scintillator layer and a transmission oxide layer. The substrate transmits the X-ray. The reflection layer is formed on the substrate to transmit the X-ray and reflect the visible light. The scintillator layer is formed on the reflection layer to convert the X-ray into the visible light. And, the oxide layer seals the scintillator layer, transmits the visible light and blocks the penetration of moisture.

### CROSS-REFERENCE TO RELATED APPLICATIONS

This application claims the benefit under 35 U.S.C. Section 119 of Korean Patent Application Serial No. 10-2012-0116547, entitled filed Oct. 19, 2012, which is hereby incorporated by reference in its entirety into this application.

### BACKGROUND

1. Field

The present disclosure relates to a scintillator panel of a medical X-ray detecting device and a manufacturing method thereof, and more particularly, to a scintillator panel of an indirectly-deposited method to combine the scintillator panel to an imaging device after the scintillator panel is manufactured and a manufacturing method thereof.

2. Description of the Related Art

In the case of medical X-ray photography, the digital radiation imaging devices have been widely used to obtain an image using the radiation detectors without the use of the film and to display a photographed image by transmitting the image to a computer.

The digital radiation imaging devices can be classified into a direct conversion method and an indirect conversion method, the direct conversion method is a method to implement the images by directly converting the irradiated X-ray into an electric signal and the indirect conversion method is a method to implement the images after converting the X-ray into visible light and converting the visible light into the electric signal by using an imaging device such as a photodiode, a CMOS and a CCD sensor or the like. Since the direct conversion method can perform the detection only when a high voltage is applied, the indirect conversion method has been widely used.

In the case of the indirect conversion method, it utilizes a scintillator to convert the X-ray into the visible light and is classified into a direct method and an indirect method according to a method of integrating the scintillator and the imaging device. The direct method is to directly deposit the scintillator layer on the imaging device and the indirect method is to manufacture a scintillator panel obtained by depositing the scintillator layer on a substrate first and to attach it to the imaging device panel by using an adhesive.

In viewing the published patent 10-2011-0110762 (SCINTILLATOR PANEL AND RADIATION IMAGE SENSOR), the indirectly-deposited scintillator panel is disclosed. The conventional indirectly-deposited scintillator panel includes a substrate to transmit a radiation, a reflective metal thin film formed on the substrate, a scintillator layer formed on the reflective metal thin film and a protection layer to seal the scintillator layer and or the like. Herein, the protection layer is made of a material such as polyparaxylene, polymonochloro paraxylene, polydichloro paraxylene, polytetrachloro paraxylene, polyfluoro paraxylene, polydimethyl paraxylene and polydiethyl paraxylene or the like.

Like this, a polymer based material such as a polyparaxylylene film or a parylene film is included as a protection film of the conventional scintillator layer, the polymer based material is easily destructed when the ray of high energy such as UV and X-ray or the like as well as the performance of the products may be deteriorated as the polymer based protection layer is gradually aged. And also, since the polymer based material plays a role of weakening intensity of the visible light, it causes to deteriorate the resolution of data to be displayed. Particularly, in order to increase the resolution or the like, in case when the intensity of the X-ray is increased, it retrogresses to the function as the medical device. Accordingly, it is required to prepare an optical and technical means to receive the visible light generated from the scintillator as much as possible.

### SUMMARY

The present disclosure has been achieved in order to improve the structure of the scintillator according to such scintillator panel structure of the conventional indirect-deposited method and it is, therefore, an object of the present disclosure to provide an indirectly-deposited scintillator panel capable of maintaining physical characteristics, although the X-ray is radiated first, maximally transmitting the visible light generated at the scintillator layer to the imaging device second, and freely controlling the transmission characteristics of the visible light third.

The indirectly-deposited scintillator panel according to some embodiments of the present invention to achieve the above-described objects includes a substrate, a reflection layer, a scintillator layer and an oxide layer.

The substrate is made of an amorphous carbon to transmit the X-ray.

The reflection layer is formed on the substrate to transmit the X-ray and reflect the visible light.

The scintillator layer is formed on the reflection layer to convert the X-ray into the visible light.

The oxide layer is formed on the scintillator layer to transmit the X-ray and prevent the moisture from being penetrated.

In the indirectly-deposited scintillator panel according to some embodiments of the present invention, the oxide layer is a structure obtained by depositing a first oxide layer having a refractive index from 1.0 to 2.0 and a second oxide layer having a refractive index from 2.0 to 3.0. Herein, the first oxide layer is a SiO₂ layer and the second oxide layer is TiO₂ layer and the depositing number of the oxide layer can be selected from 2 to 31. And, oxide layer having the refractive index near to that of the scintillator layer is deposited on the scintillator layer at first.

In the indirectly-deposited scintillator panel according to some embodiments of the present invention, a protection layer formed on the oxide layer for transmitting the visible light and preventing the moisture from being penetrated is further included.

A method for manufacturing an indirectly-deposited scintillator panel according to some embodiments of the present invention includes preparing a substrate to transmit an X-ray; forming a reflection layer on the substrate to transmit the X-ray and reflect a visible light; forming a scintillator layer on the reflection layer to convert the X-ray into the visible light; and forming an oxide layer on the scintillator layer for transmitting the visible light, reflecting the X-ray and preventing moisture from being penetrated.

The method for manufacturing the indirectly-deposited scintillator panel according to some embodiments of the present invention includes the steps of forming a first oxide layer having a refractive index from 1.0 to 2.0; and forming a second oxide layer having a refractive index from 2.0 to 3.0, wherein the above forming steps can be repeated many times. Herein, the first oxide layer is a SiO₂ layer and the second oxide layer is TiO₂ layer. And, in forming the oxide layer, the oxide layer having the refractive index near to that of the scintillator layer is deposited on the scintillator layer at first.

In the method for manufacturing the indirectly-deposited scintillator panel according to some embodiments of the present invention, forming the oxide layer utilizes a sputtering with a process pressure from several tens to several hundreds of mTorr, an ion auxiliary vacuum deposition with a process pressure below 10⁻⁵ Torr or a substrate inclination revolution/rotation method.

In the method for manufacturing the indirectly-deposited scintillator panel according to some embodiments of the present invention, a step of forming a protection layer on the oxide layer for transmitting the X-ray and preventing the moisture from being penetrated is further included.

### BRIEF DESCRIPTION OF THE DRAWINGS

FIG. 1 is a cross-sectional view showing an indirectly-deposited scintillator panel having a monolayer oxide layer according to some embodiments of the present invention;

FIG. 2A is a cross-sectional view showing an indirectly-deposited scintillator panel having a multi-layer oxide layer according to some embodiments of the present invention;

FIG. 2B is a graph showing a transmission property of the oxide layer in the indirectly-deposited scintillator panel according to some embodiments of the present invention;

FIG. 3 is a flowchart showing a method for manufacturing an indirectly-deposited scintillator panel according to some embodiments of the present invention;

FIG. 4A is a cross-sectional view showing an indirectly-deposited scintillator panel having a protection layer according to some embodiments of the present invention;

FIG. 4B is a flowchart showing a method for manufacturing an indirectly-deposited scintillator panel having the protection layer of FIG. 4A; and

FIG. 5 is a cross-sectional view showing that the indirectly-deposited scintillator panel is combined to the imaging device.

### DETAILED DESCRIPTION OF THE PREFERABLE EMBODIMENTS

Exemplary embodiments of the present invention to achieve the above-described objects will be described with reference to the accompanying drawings. In this description, the same elements are represented by the same reference numerals, and additional description which is repeated or limits interpretation of the meaning of the invention may be omitted.

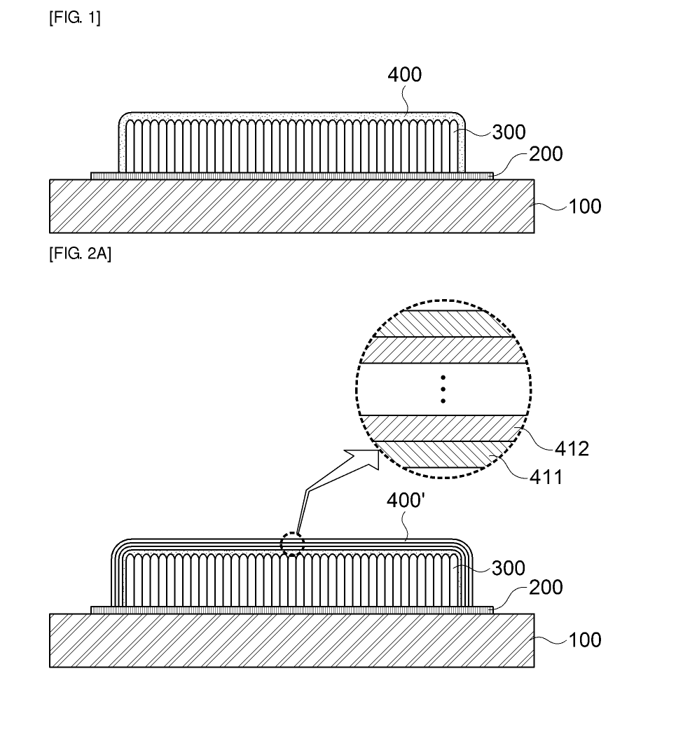

FIG. 1 is a cross-sectional view showing an indirectly-deposited scintillator panel having a monolayer oxide layer according to some embodiments of the present invention.

As shown in FIG. 1, the indirectly-deposited scintillator panel includes a substrate 100, a reflection layer 200, a scintillator layer 300 and an oxide layer 400.

The substrate 100 is made of a material capable of transmitting the X-ray, for example, glass and Pyrex or the like. In case of an amorphous carbon (a-C) (glass carbon or glassy carbon, since it has some degree of stiffness even when it is largely formed, the warpage of the substrate 100 is suppressed although the scintillator layer 300 is formed on the substrate 100.

The reflection layer 200 transmits the X-ray transmitted through the substrate 100 to the scintillator layer 300 and is made of a material capable of the visible light converted in the scintillator layer 300. Although the reflection layer 200 is made of a conventional metal thin film, e.g., Ag or Al, but Cr, Cu, Ni, Ti, Mg, Rh, Pt and Au or the like can be used. Also, the multi-layer can be formed, e.g., after the Cr layer is formed first and the Au layer is formed thereon.

The protection layer can be further formed on the reflection layer 200, in case when the reflection layer 200 may be formed of Al, Ag, Cr, Cu, Ni, Ti, Mg, Rh and Pt or the like, the oxide layer thereof can be utilized as the protection layer.

The scintillator layer 300 is deposited on the reflection layer 200. The scintillator layer 300 is deposited in a shape of a column structure. Each column structure of the scintillator layer 300 has a sharp shape toward a top portion without being flat at its top portion. The thickness of the scintillator layer 300 is from approximately 2- to 2,000 μm. The scintillator layer 300 converts the incident radiation ray into the light of visible region which can be detected by the light receiving device of the imaging device.

The scintillator layer 300 is not limited in its type if it can convert the radiation ray into the visible light. For example, Csl, Csl doped with thallium (TI), Csl doped with natrium (Na) and Nal doped with thallium (TI) or the like can be utilized. Among those, in in some embodiments of the present invention, the Csl doped with thallium (TI) is utilized, since it emits the visible light and has excellent light emission efficiency.

Since the Csl forming the scintillator layer 300 is a hygroscopic material, it melts if absorbs the moisture in the air. That is, if the moisture is in contact with the scintillator layer 300, the scintillator layer 300 is damaged to thereby degrade the resolution of the image obtained from the imaging device. Accordingly, it is very important to prevent the scintillator layer 300 from being in contact with the moisture.

The oxide layer 400 is formed on the scintillator layer 300. The oxide layer 400 protects the scintillator layer 300 from the moisture by blocking the penetration of moisture. And also, the oxide layer 400 transmits the visible light. That is, the visible light converted in the scintillator layer 300 is transmitted and transferred to a direction of the imaging device.

The oxide layer 400 is consisting of an oxide layer such as a metal. For example, SiO₂, TiO₂ and Ta₂O₃ the like can be utilized.

The oxide layer 400 can be formed by using a physical vapor deposition such as an electron beam deposition, a sputtering and a thermal evaporation or a chemical vapor deposition or the like. In some embodiments of the present invention, since the whole surface of the scintillator layer 300 is deposited with the oxide layer 400, the oxide layer 400 is deposited on the scintillator layer 300 with a high pressure sputtering method having excellent step coverage. The process pressure of the high pressure sputtering is ranged from several tens to several hundreds of mTorr.

The oxide layer 400 can be formed to reflect a specific wavelength range among the visible light. The visible light has a wavelength bandwidth from 400 to 700 nm, it is classified into a blue region having a wavelength range from 400 to 500 nm, a green region having a wavelength range from 500 to 600 nm and a red region having a wavelength range from 600 to 700 nm. But, the light receiving element cannot receive the full bandwidth of the visible light according to the degree of depth that the light receiving element is formed in the substrate. For example, if the light receiving element is formed in the substrate to a depth of 4 to 5 μm, the light receiving element can detect the lights of blue region and green region, but the light receiving element cannot detect the light of red region having a bandwidth of 600 to 700 nm. Accordingly, since the wavelength bandwidth of the visible light to be reflected is determined according to the formation depth of the light receiving element, when the oxide layer 400 is formed, its depth can be constructed to maximize the reflectivity in the effective reflection bandwidth when the oxide layer is formed.

FIG. 2A is a cross-sectional view showing an indirectly-deposited scintillator panel having a multi-layer oxide layer according to some embodiments of the present invention.

As shown in FIG. 2A, the oxide layer 400′ can be formed by depositing a plurality of oxide layers having different refractivity from each other. As shown in FIG. 1, if the oxide layer 400 is formed with a single layer, it cannot obtain sufficient reflectivity. But, as shown in FIG. 2A, if the plurality of oxide layers 411 and 412 are deposited and the type or the number of the deposited oxide layers 411 and 412 is controlled, the reflectivity which cannot be obtained from the oxide layer 400 formed of the single layer can be obtained.

For example, the oxide layer 400′ can be formed by depositing a number of first oxide layers 411 and the second oxide layers 412, wherein a material having the reflectivity from 1.0 to 2.0 is selected as the first oxide layer 411 and a material having the reflectivity from 2.0 to 3.0 is selected as the second oxide layer 412. But, if the oxide layer 400′ is formed by depositing only two oxide layers 411 and 412, the reflectivity is not satisfied. However, if a plurality of SiO₂ films and TiO₂ films, e.g., at least 3 numbers of layers are deposited with different thicknesses from each other, it can obtain the reflectivity above 90% at broad wavelength bandwidth and it can be called as a cut-off filter.

Also, when forming with a plurality of oxide layers 400′, the type, the number of depositing, the thickness of the oxide layers 411 and 412 can be controlled so as to maximize the effective reflectivity of the visible light according to the installation depth of the light receiving element.

FIG. 2B is a graph showing a transmission property of the oxide layer in the indirectly-deposited scintillator panel according to some embodiments of the present invention.

As shown in FIG. 2B, the oxide layer 400′ reflects almost 100% of the visible light bandwidth from 300 to 600 nm, and transmits almost 100% of the light of the other region. The filter characteristics of the oxide layer as shown in FIG. 2B can be obtained by controlling the type, the depositing number and the thickness of the plurality of oxide layers having different refractive indexes.

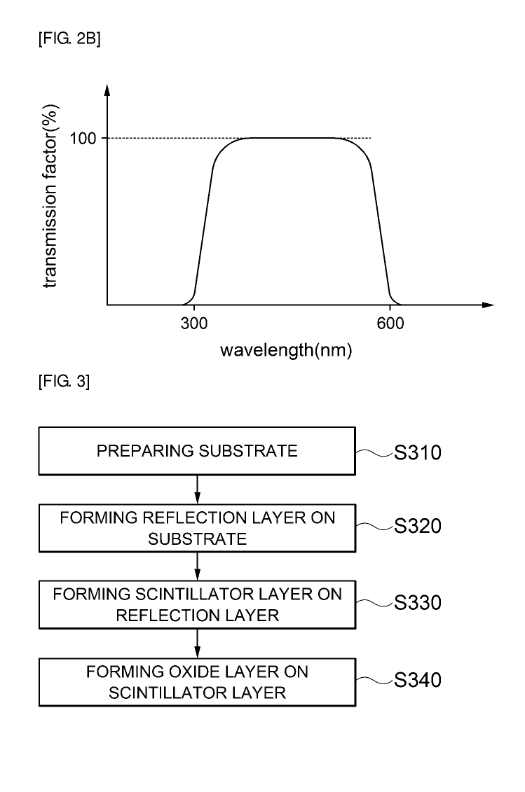

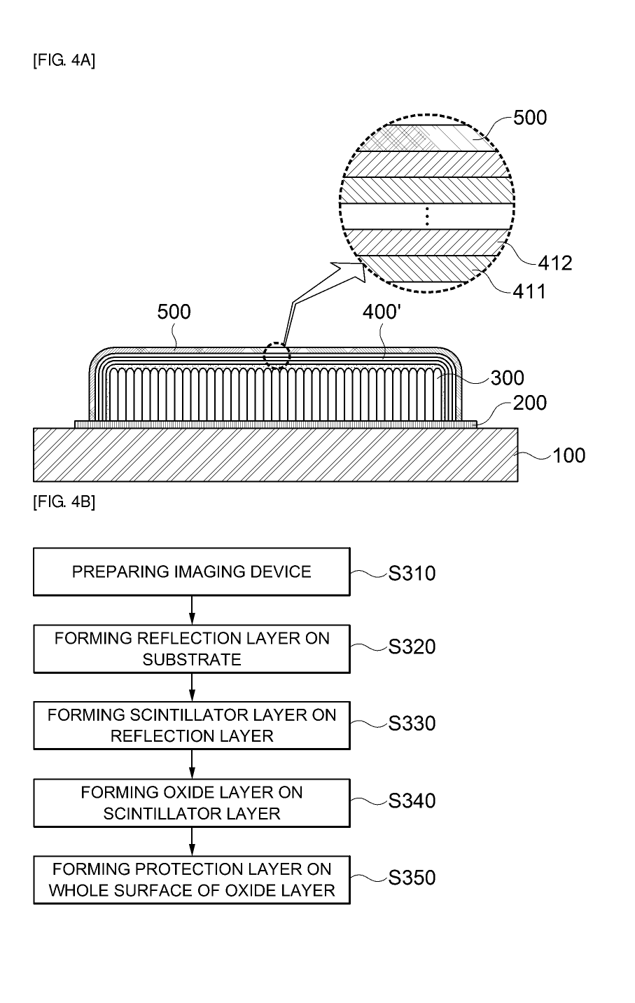

FIG. 3 is a flowchart showing a method for manufacturing an indirectly-deposited scintillator panel according to some embodiments of the present invention.

As shown in FIG. 3, the glass substrate 100 is inserted into a deposition chamber to be supported (S310).

In the deposition chamber, the reflection layer 200 is formed on one surface of the substrate 100 by using an evaporation method or a sputtering (S320). The reflection layer 200 may be an oxide layer obtained by repeatedly depositing, e.g., an Al film having a thickness of 100 nm or two materials having different reflective indexes, at a range of 2 to 31 layers.

In the deposition chamber, the scintillator layer 300 is deposited on the reflection layer 200 (S330). In some embodiments of the present invention, the scintillator layer 300 is formed without deviating from the formation surface of the reflection layer 200 in order to increase the reflectivity efficiency of the reflection layer 200. The scintillator layer 300 is formed on the reflection layer 200 in a shape of column. In this result, the top portion of the scintillator layer 300 is uneven and forms a rugged surface.

Thereafter, in the deposition chamber, the oxide layer 400 to seal the scintillator layer 300 is formed. Herein, the oxide layer protects the scintillator layer 300 from the moisture. Also, it has the characteristics to transmit the light of visible region generated in the scintillator layer 300 to the imaging device.

Since the upper most stage of the scintillator layer 300 has crystals having different heights from each other, the step coverage should be good when the oxide layers 400 and 400′ are deposited on the scintillator layer 300. In some embodiments of the present invention, the deposition process of the oxide layers 400 and 400′ is a physical vapor deposition (PVD), wherein the PVD can be an evaporation method or a sputtering method.

In case when the oxide layers 400 and 400′ are formed by applying the evaporation method, since the process is performed under a pressure below 10⁻⁵ Torr, the evaporated materials are incident on the surface of the scintillator layer 300, the reflection layer 200 or the substrate 100 with an almost rectilinear movement. Accordingly, in order to improve the step coverage of the oxide layers 400 and 400′, so-called substrate inclination revolution/rotation method, that is, the angle of the evaporation materials to be incident on the scintillator layer 300 or the reflection layer 200 is ranged from 0 to 45 degrees, and the method to deposit with revolving/rotating can be utilized. In order to this, an apparatus provided with a substrate supporting unit in a shape of dome is required.

And also, when the oxide layers 400 and 4000′ are deposited by the evaporation method, in order to improve the compactness of the oxide layers 400 and 400′, an ion beam assisted deposition (IBED) can be utilized.

In case when the oxide layers 400 and 400′ are evaporated by using the sputtering method, since the process pressure is very higher than that of the evaporation method, the target materials to be sputtered and reached at the substrate can be deposited with various incidence angles. Accordingly, although an additional substrate support apparatus is not used in the sputtering method, the step coverage is excellent. In this case, after the substrate 100 on which the reflection layer 200 and the scintillator layer 300 are formed is moved to the sputtering chamber, the oxide layers 400 and 400′ are formed under the high process pressure from several tens to several hundreds of mTorr.

When the oxide layer 400′ is deposited by the evaporation method or the sputtering method, the layer is formed by sequentially and alternately depositing an oxide layer of a first material having a refractive index from 1.0 to 2.0 and an oxide layer of a second material having a refractive index from 2.0 to 3.0. At this time, the oxide layer which is in contact with the scintillator layer 300 may be the first material or the second material. Merely, the material having the refractive index close to that of the scintillator layer 300 can be deposited first.

When the oxide layer 400′ is formed by depositing 2-31 number of layers, the thickness of each oxide layer can be controlled so as to optimally reflect the ray of visible region generated in the scintillator layer 300 at the oxide layer 400′ and the number of the whole deposited oxide layers can be controlled.

The top surface of the scintillator layer 300 is sealed by the oxide layers 400 and 400′ and the side surface thereof is also sealed. In this result, the oxide layer 400 transmits the visible light generated in the scintillator layer 300 almost 100% to the direction of the imaging device and also can protect the scintillator layer 300 by preventing the moisture from being penetrated.

FIG. 4A is a cross-sectional view showing an indirectly-deposited scintillator panel having a protection layer according to some embodiments of the present invention.

As shown in FIG. 4A, in the indirectly-deposited scintillator panel according to some embodiments of the present invention, a protection layer 500 can be further formed on the oxide layer 400. If the visible light is transmitted and the moisture is blocked, the material to form the protection layer 500 is not limited. For example, an organic resin, specifically parylene resin, can be used. As the parylene is the proprietary name of the chemically deposited poly p-xylene polymer, it includes parylene N, parylene C, parylene D, and parylene AF-4 or the like, and the coating film of the parylene has small penetration of the moistures or the gases, high water repellency and chemical resistance, excellent electric insulation, and also can transmit the visible light.

The protection layer 500 can be deposited by a physical vapor deposition (PVD) or a chemical vapor deposition (PVD) or the like.

FIG. 4B is a flowchart showing a method for manufacturing an indirectly-deposited scintillator panel having the protection layer of FIG. 4A.

The manufacturing method of FIG. 4B further includes a step of forming the protection layer 500 on the oxide layer 400 in comparison with the manufacturing method of FIG. 3 (S350). The protection layer 500 is formed by depositing the parylene or the like in the deposition chamber.

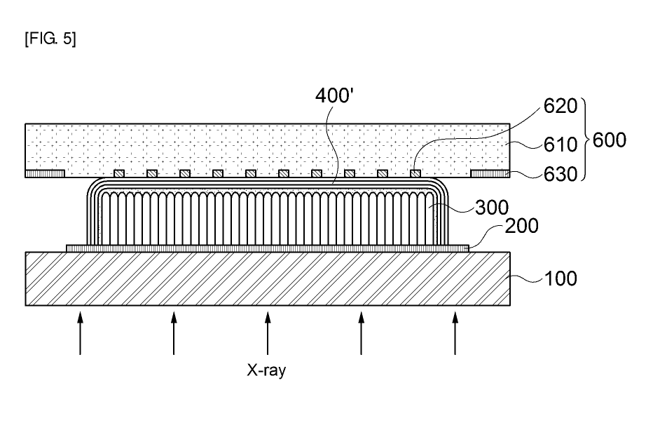

FIG. 5 is a cross-sectional view showing that the indirectly-deposited scintillator panel is combined to the imaging device.

As shown in FIG. 5, the indirectly-deposited scintillator panel according to some embodiments of the present invention is combined with the light receiving surface of an imaging device 600 through the adhesive by facing the oxide layer 400 to the direction of the imaging device 600.

The imaging device 600 includes a plurality of light receiving elements 620 and a plurality of electrode pads 630 or the like. The light receiving elements 620 is arranged at the center surface of a substrate 610 and the electrode pads 630 are arranged at the edge surface of the substrate 610.

The light receiving elements 620 are photoelectric conversion devices arranged and formed on the substrate 610 made of silicon or glass in one dimension or two dimensions. The light receiving elements 620 detect the visible light converted by the scintillator layer 300 and convert it into an electric signal. A photodiode or a thin film transistor can be utilized as the light receiving elements 620.

The electric pads 630 are formed on a surface edge of the substrate 610 in plural. The electrode pads 630 read the electric signal generated by the light receiving elements 620 and transmit it to an image analyzing apparatus. The electrode pads 630 are electrically connected to the light receiving elements 620 through a wiring such as a wire.

According to some embodiments of the present invention having such constructions and steps, the performance of the scintillator panel can be maintained for a long time due to the oxide layer which maintains its physical property for a long time even when the X-ray is scanned. Also, in case when the transmission characteristics of the visible light can be maximized by controlling the depositing number or the thickness or the like of the oxide layer, the visible light generated in the scintillator layer can be maximally transmitted to the imaging device.

The above-described embodiments and the accompanying drawings are provided as examples to help understanding of those skilled in the art, not limiting the scope of the present disclosure. Further, embodiments according to various combinations of the above-described components will be apparently implemented from the foregoing specific descriptions by those skilled in the art. Therefore, the various embodiments of the present invention may be embodied in different forms in a range without departing from the essential concept of the present disclosure, and the scope of the present disclosure should be interpreted from the subject matter recited in the claims. It is to be understood that the present disclosure includes various modifications, substitutions, and equivalents by those skilled in the art.

1. A scintillator panel, comprising:
a substrate configured to transmit an X-ray;
a reflection layer formed on the substrate and configured to transmit the X-ray and reflect visible light;
a scintillator layer formed on the reflection layer and configured to convert the X-ray into the visible light; and
an oxide layer formed on the scintillator layer and configured to transmit the visible light, reflect the X-ray, and prevent moisture penetration.

2. The scintillator panel according to claim 1, wherein the oxide layer is a structure including a first oxide layer having a refractive index from 1.0 to 2.0 and a second oxide layer having a refractive index from 2.0 to 3.0.

3. The scintillator panel according to claim 2, wherein
the first oxide layer is a SiO₂ layer and the second oxide layer is TiO₂ layer, and
a number of layers in the structure is from 2 to 31.

4. The scintillator panel according to claim 2, wherein the first oxide layer or the second oxide layer having the refractive index closer to that of the scintillator layer is formed on the scintillator layer first.

5. The scintillator panel according to claim 1, further comprising a protection layer formed on the oxide layer and configured to transmit the X-ray and prevent the moisture penetration.

6. A method of manufacturing a scintillator panel, the method comprising:
forming a reflection layer on a substrate, the substrate being configured to transmit an X-ray, the reflection layer being configured to transmit the X-ray and reflect visible light;
forming a scintillator layer on the reflection layer, the scintillator layer being configured to convert the X-ray into the visible light; and
forming an oxide layer on the scintillator layer, the oxide layer being configured to transmit the visible light, reflect the X-ray, and prevent moisture penetration.

7. The method according to claim 6, wherein the forming an oxide layer includes
forming a first oxide layer having a refractive index from 1.0 to 2.0; and
forming a second oxide layer having a refractive index from 2.0 to 3.0.

8. The method according to claim 7, wherein
the first oxide layer is a SiO₂ layer and the second oxide layer is TiO₂ layer, and
a number of layers in the oxide layer is from 2 to 31.

9. The method according to claim 7, wherein, in the forming an oxide layer, the first oxide layer or the second oxide layer having the refractive index closer to that of the scintillator layer is formed on the scintillator layer first.

10. The method according to claim 6, wherein the forming an oxide layer includes sputtering with a process pressure from several tens to several hundreds of mTorr.

11. The method according to claim 6, wherein the forming an oxide layer includes sputtering with an ion auxiliary vacuum deposition with a process pressure below 10⁻⁵ Torr.

12. The method according to claim 6, wherein the forming an oxide layer includes sputtering with a substrate inclination revolution/rotation method.

13. The method according to claim 10, further comprising forming a protection layer on the oxide layer, the protection layer configured to transmit the X-ray and prevent the moisture penetration.

14. The method according to claim 11, further comprising forming a protection layer on the oxide layer, the protection layer configured to transmit the X-ray and prevent the moisture penetration.

15. The method according to claim 12, further comprising forming a protection layer on the oxide layer, the protection layer configured to transmit the X-ray and prevent the moisture penetration.
